(19) United States
(12) Patent Application Publication
(10) Pub. No.: US 2004/0190810 A1
(43) Pub. Date: Sep. 30, 2004

(54) Polarization controller and light network system using the same

(76) Inventors: Shih-Chieh Chang, Taipei County (TW); Chii-How Chang, Taoyuan (TW)

Correspondence Address: MARTINE & PENILLA, LLP, 710 LAKEWAY DRIVE, SUITE 170, SUNNYVALE, CA, 94085, US

(21) Appl. No.: 10/461,595

(22) Filed: Jun. 12, 2003

(30) Foreign Application Priority Data
Mar. 25, 2003 (TW) 92106565

(51) Int. Cl. G02B 6/26

(52) U.S. Cl. 385/11; 385/27

(57) ABSTRACT

A polarization controller includes a light refracting device, a guidance layer, a waveguide layer and a polarization device. The light refracting device has at least two corresponding surfaces. The guidance layer is disposed on one of the surfaces, and is able to refract light having a specific polarization state. The waveguide layer is disposed on the guidance layer, and the refractive index of the waveguide layer is larger than that of the guidance layer. The polarization device is disposed on the other surface.

### BACKGROUND OF THE INVENTION

(a) Field of the Invention

The invention relates to a polarization controller and a light network system using the same and, more particularly, to a polarization controller capable of adjusting the polarization state of light, and a light network system that increases transmission amounts of optical signals using the polarization controller.

(b) Description of the Related Art

Development of opto-communication systems is a focus in technical fields during the recent years. Owing to discover of optical fibers, maturation of semiconductor fabrication techniques and progressing of micro-electro-mechanical (MEM) processes, the opto-communication systems continuously advances as a result.

A fundamental principle behind opto-communication systems is that traveling of light waves is utilized for transmitting data, which are generally referred to as optical signals. In a conventional data transmission process, light having a specific wavelength is for representing a certain data. However, at the current time, existing optical fiber transmission capabilities and wavelength ranges of light for transmission have become inadequate with respect to amounts of data that need to be transmitted. Therefore, it is a vital task as how to significantly increase transmission amounts of optical signals.

### SUMMARY OF THE INVENTION

An object of the invention is to provide a polarization controller for easily controlling modes of an output light.

The other object of the invention is to provide a light network system for significantly increasing transmission amounts of optical signals.

To achieve the aforesaid objects, the invention provides a polarization controller including a refractive device, a guidance layer, a waveguide layer and a polarization device. The refractive device has at least two corresponding surfaces. The guidance layer is disposed on one of the aforesaid surfaces, and is for refracting light having a specific polarization state. The waveguide layer is disposed on the guidance layer, and a refractive index of the waveguide layer is larger than that of the guidance layer. The polarization device is disposed on the other surface.

In the polarization controller in accordance with the invention, a specific polarization state of light that can be refracted by the guidance layer is varied along with incident angles of the light, and the refractive index of the guidance layer is larger than that of air.

Also, the polarization controller in accordance with the invention can be provided with a rotating mechanism located on a path that the light is incident to the light refracting device, so as to change the incident angle of the light. The polarization controller in accordance with the invention may further be provided with a light guide member connected with the waveguide layer and for transmitting the light.

Furthermore, the invention provides a light network system having an optical signal transmission device, an optical signal reception device, and a plurality of optical signal transferring devices. The optical signal transmission device transmits a plurality of optical signals, whereas the optical signal reception device receives the plurality of optical signals. The optical signal transferring devices are connected between the optical signal transmission device and the optical signal reception device, and each optical signal transferring device is capable of transforming the received optical signals into a specific polarization state for further transmission.

In addition, the optical signal transferring devices used in the light network system can be the polarization controllers.

From the above, the polarization controller in accordance with the invention is capable of adjusting the polarization state of light to a required polarization state by changing the incident angle of the light. Thus, the optical signals can be transmitted at the same polarization state.

Moreover, when light having multiple polarization states (for instance, having two polarization states) is incident to the polarization controller of the invention, because of the provided mechanism for changing the polarization state of the light, light with a single polarization state is output with almost zero energy loss.

Yet, since the optical signal transmission device outputting optical signals with a single polarization state is used in the light network system in accordance with the invention, it is efficient in transmitting greater amounts of optical signals than conventional light network systems, which are only capable of transmitting optical signals of certain wavelengths.

Also, since the light network system in accordance with the invention provides a mechanism for changing the polarization state of the light, it is capable of outputting light having a single polarization state with almost zero energy loss. As a result, the light network system in accordance with the invention is able to increase transmission amounts of optical signals while maintaining original energy without attenuation.

The above and other objects, advantages, and features of the invention will become apparent from the following description with reference to the accompanying drawings.

### BRIEF DESCRIPTION OF THE DRAWINGS

FIG. 1 is a schematic view illustrating the polarization controller in accordance with an embodiment of the invention.

FIG. 2 is a curve diagram illustrating the incident angle and the refractive index in accordance with an embodiment of the invention.

FIG. 3 is a schematic view illustrating the light network system in accordance with an embodiment of the invention.

### DETAILED DESCRIPTION OF THE PREFERRED EMBODIMENTS

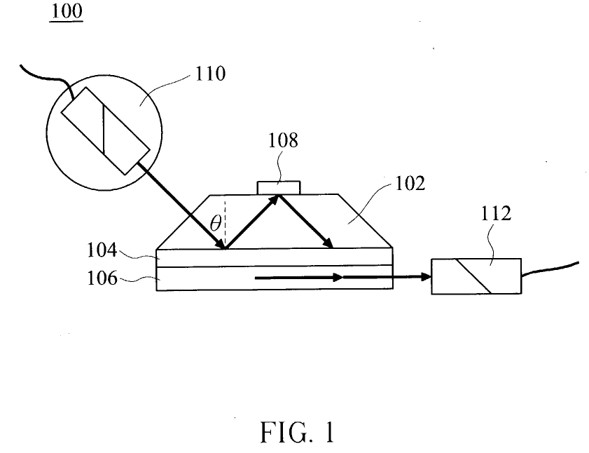

Referring to FIG. 1, the polarization controller 100 includes a light refracting device 102, a guidance layer 104, a waveguide layer 106, and a polarization device 108. The waveguide layer 106 has a refractive index larger than that of the guidance layer 104.

Other elements of the polarization controller 100 will be described below. The light refracting device 102 functions as an optical path member for light to be incident to the polarization controller 100, or for reflecting the light within the polarization controller 100. The light refracting device 102 is made from a material such as glass.

The guidance layer 104 is disposed on a surface of the light refracting device 102, and is made from a material that can refract light having a specific polarization state, which is varied with an incident angle θ of the light. The material may be polymethylmethacrylate (PMMA). The guidance layer 104 is formed by, for example, a coating method. In addition, the incident angle θ is an included angle between a direction of an incident light and a normal direction of an incident plane on the guidance layer 104. Also, the guidance layer 104 may reflect light apart from the light having the polarization state.

The waveguide layer 106 is disposed on the guidance layer 104, and has a refractive index larger than that of the guidance layer 104 or air. The waveguide layer 106 is an inorganic or organic film having a refractive index larger than that of the guidance layer 104. For example, the waveguide layer 106 may be a polyimide film. At two sides of the waveguide layer 106 are the guidance layer 104 and air, respectively, each having a smaller refractive index. Therefore, light incident to the waveguide layer 106 has total reflection within the waveguide layer 106. The light then travels toward a transmission direction predetermined by the polarization controller 100.

The polarization device 108 is disposed on the other surface of the light refracting device 102, and this surface is parallel to the surface formed with the guidance layer 104. The polarization device 108 is capable of changing a polarization state of light incident to the polarization device 108, and reflecting light having a changed polarization state. The polarization device 108 may be, for example, a birefringent crystal, a multiple quantum-well waveguide, or a quarter-wave plate.

Furthermore, the polarization controller 100 in accordance with the invention may be provided with a rotating mechanism 110 between a light source and the light refracting device 102 for rotating light from the light source to a particular angle. The rotated light is then incident to the light refracting device 102. As a result, the angle θ of the light incident to the light refracting device 102 can be easily adjusted.

In addition, the polarization controller 100 in accordance with the invention may be provided with a light guide member 112 for sending light from the guidance layer 106 to light reception device as described below. The light guide member 112 may be, for instance, a polarization-maintaining optical fiber or collimator.

An example will be given for illustrating the operation of the polarization controller 100 in accordance with the invention. In this example, conditions of the polarization controller 100 are set as below. The light refracting device 102 is a prism. The guidance layer 104 is made from PMMA, and has a thickness of about 1.47 μm and a refractive index of 1.4. The waveguide layer 106 is made from polyimide, and has a thickness of about 9 μm and a refractive index of 1.6. The polarization device 108 is a quarter-wave plate.

Referring to FIG. 1, parallel light is incident to the light refracting device 102 and the guidance layer 104 with an incident angle θ. The parallel light has a polarization state perpendicular to the horizontal plane (this polarization state is referred to as TE) and a polarization state parallel to the horizontal (this polarization state is referred to as TM). Also, the guidance layer 104 only refracts light having a polarization state corresponding to this incident angle θ.

Suppose the light is incident at an angle θ, and the guidance layer 104 is capable of refracting light having the TM polarization state and reflects light having the TE polarization state, then the light having the TM polarization state is refracted into the guidance layer 104, whereas the light having the TE polarization state is reflected back into the light refracting device 102.

When the light having the TE polarization state travels to the polarization device 108, the polarization device 108 changes the polarization state of the light to a corresponding polarization state, and then reflects light having a changed polarization state. When the reflected light travels to the guidance layer 104, the light can be totally refracted into the guidance layer 104 for that the light has a polarization state that can be refracted.

The light having the TM polarization state is refracted into the waveguide layer 106 after being incident to the guidance layer 104. At this moment, due to refractive indices of the two sides of the waveguide layer 106 being smaller than the refractive index of the waveguide layer 106, the light incident to the waveguide layer 106 has a total reflection within the waveguide layer 106 so that the light is forwarded toward a predetermined direction.

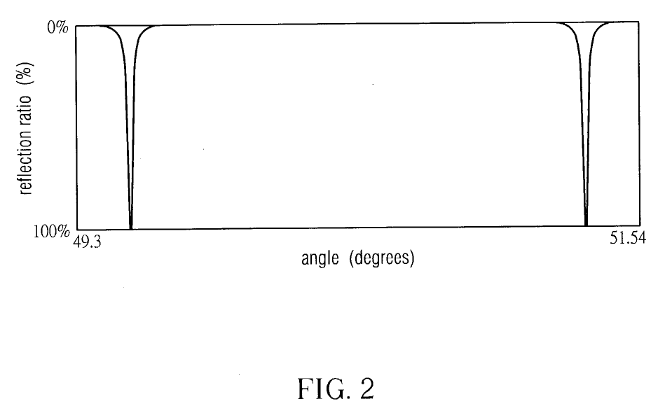

In addition, when the incident angle θ varies, the waveguide layer 106 can also refract light having the TE polarization state and reflect light having the TM polarization state. FIG. 2 shows the results of implementation of the example. Referring to FIG. 2, when the incident angle is about 49.3 degrees, light having the TE polarization state is reflected, whereas when the incident angle is 51.5 degrees, light having the TM polarization state is refracted.

It is noted from the above that, the polarization controller in accordance with the invention changes a polarization state of incident light to a polarization state required through adjusting an incident angle of the light. Therefore, optical signals can be transmitted with the same polarization state.

Moreover, when light having multiple polarization states (light having two polarization states, for example) is incident to the polarization controller in accordance with the invention, because of the provided mechanism for changing the polarization state of the light, light having a single polarization state is output with almost zero energy loss.

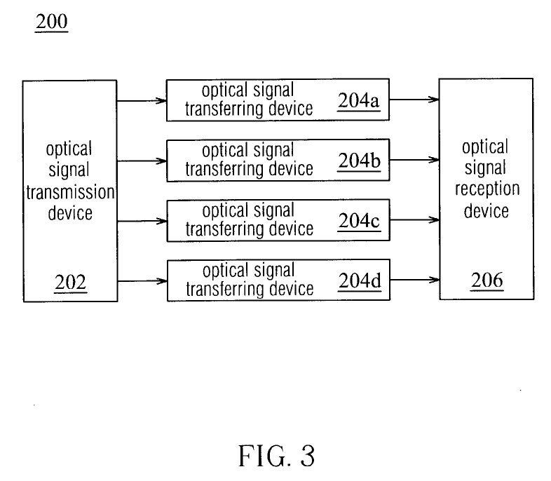

Another example will be given for illustrating effects of application of the polarization controller in accordance with the invention. Referring to FIG. 3, a light network system 200 includes an optical signal transmission device 102, an optical signal reception device 206 and a plurality of optical signal transferring devices 204a, 204b, 204c and 204d. The optical signal transferring devices 204a, 204b, 204c and 204d are disposed between the optical signal transmission device 202 and the optical signal reception device 206. Also, the light network system 200 is, for instance, a dense wavelength-division multiplexer (DWDM).

The optical signal transmission device 202 is a device capable of transmitting multiple optical signals having different wavelengths. The optical signal transmission device 202 may further be provided with a data conversion circuit (not shown). The data conversion circuit converts received data signals into optical signals, and then transmits the optical signals from the optical signal transmission device 202 to the optical signal transferring devices 204a, 204b, 204c and 204d.

The optical signal reception device 206 is a device capable of receiving multiple optical signals having different wavelengths. The optical signal reception device 206 may further be provided with a data conversion circuit (not shown). The data conversion circuit converts the optical signals into data signals, and then transmits the data signals to other devices.

The structure and operating principle of the optical signal transferring devices 204a, 204b, 204c and 204d are the same as those of the polarization controller 100, and therefore shall not be unnecessarily described further. The optical signal transferring devices 204a, 204b, 204c and 204d receive optical signals from the optical signal transmission device 202, and, provided that the wavelengths are from a same source, are capable of transferring optical signals having a single polarization state to the optical signal reception device 206. Moreover, before transferring optical signals having the same polarization state, the optical signal transferring devices 204a, 204b, 204c and 204d may also entirely convert the optical signals having two polarization states into optical signals having a single polarization state for further transferring.

It is known from the above that, the polarization controller in accordance with the invention is used as the optical signal transferring devices 204a, 204b, 204c and 204d in the light network system 200 in accordance with the invention. Therefore, for each wavelength range, the optical signal transferring devices 204a, 204b, 204c and 204d in accordance with the invention has twice optical path amounts than the conventional devices. That is, in a same wavelength band, the transmission amounts of optical signals by the light network system 200 in accordance with the invention are multiplied by two.

For example, for a wavelength range approximately between 1560.61 nm (ITU21) and 1554.94 nm (ITU28), a conventional light network system has merely 8 available optical paths of which each uses an individual wavelength range; whereas in the light network system in accordance with the invention, each wavelength range is divided into two paths namely the TE polarization and the TM polarization. Thereby, the light network system in accordance with the invention can transmit optical signals having twice amounts than those of the prior art.

In addition, the light network system in accordance with the invention, because of the provided mechanism for changing the polarization state of the light, is capable of outputting light having a single polarization state with almost zero energy loss. As a result, the light network system in accordance with the invention is able to increase transmission amounts of optical signals while maintaining original energy without attenuation.

While the invention has been particularly described, in conjunction with specific examples, it is evident that many alternatives, modifications and variations will be apparent to those skilled in the art in light of the foregoing description. It is therefore contemplated that the appended claims will embrace any such alternatives, modifications and variations as falling within the true scope and spirit of the invention.

What is claimed is:

1. A polarization controller comprising:
a light refracting device having at least a first surface and a second surface, wherein the second surface is parallel to the first surface;
a guidance layer disposed on the first surface, and capable of refracting light having a specific polarization state;
a waveguide layer disposed on the guidance layer, and having a refractive index larger than a refractive index of the guidance layer; and
a polarization device disposed on the second surface.

2. The polarization controller as described in claim 1, wherein the specific polarization state of the light that is refracted by the guidance layer is varied according to incident angles of the light.

3. The polarization controller as described in claim 1, wherein the refractive index of the waveguide layer is larger than a refractive index of air.

4. The polarization controller as described in claim 1, wherein the guidance layer is capable of reflecting light apart from the light having the specific polarization state.

5. The polarization controller as described in claim 1, wherein the polarization device changes a polarization state of the light incident to the polarization device, and reflects the light having a changed polarization state.

6. The polarization controller as described in claim 1, further comprising a rotating mechanism located on a path that the light is incident to the light refracting device and for adjusting an incident angle of the light.

7. The polarization controller as described in claim 1, further comprising a light guide member connected with the waveguide layer and for transmitting the light.

8. The polarization controller as described in claim 1, wherein the guidance layer is made from polymethylmethacrylate (PMMA).

9. The polarization controller as described in claim 1, wherein the waveguide layer is made from polyimide.

10. The polarization controller as described in claim 1, wherein the polarization controller is selected from a group consisting of a birefringent crystal, a multiple quantum-well waveguide, and a quarter-wave plate.

11. A light network system comprising:
an optical signal transmission device for transmitting a plurality of optical signals;
an optical signal reception device for receiving the optical signals; and
a plurality of optical signal transferring devices connected between the optical signal transmission device and the optical signal reception device, and being capable of converting the optical signals into a specific polarization state and transferring the optical signals.

12. The light network system as described in claim 11, wherein each of the optical signal transferring devices comprising:
a light refracting device having at least a first surface and a second surface, wherein the second surface is parallel to the first surface;
a guidance layer disposed on the first surface, and being capable of refracting light having a specific polarization state;
a waveguide layer disposed on the guidance layer, and having a refractive index larger than a refractive index of the guidance layer; and
a polarization device disposed on the second surface.

13. The light network system as described in claim 12, wherein the specific polarization state of the light that is refracted by the guidance layer is varied according to an incident angle of the light.

14. The light network system as described in claim 12, wherein the refractive index of the waveguide layer is larger than that of air.

15. The light network system as described in claim 12, wherein the guidance layer is capable of reflecting light apart from the light having the specific polarization state.

16. The light network system as described in claim 12, wherein the polarization device changes a polarization state of the light incident to the polarization device, and reflects the light having a changed polarization state.

17. The light network system as described in claim 11, further comprising a rotating mechanism located on a path that the light is incident to the light refracting device, and for adjusting an incident angle of the light.

18. The light network system as described in claim 12, wherein the guidance layer is made from PMMA.

19. The light network system as described in claim 12, wherein the waveguide layer is made from polyimide.

20. The light network system as described in claim 12, wherein the polarization controller is selected from a group consisting of a birefringent crystal, a multiple quantum-well waveguide, and a quarter-wave plate.
